(19) United States
(12) Patent Application Publication
(10) Pub. No.: US 2018/0136577 A1
(43) Pub. Date: May 17, 2018

(54) CHARGING ROLL FOR ELECTROPHOTOGRAPHIC APPARATUS

(71) Applicant: Sumitomo Riko Company Limited, Komaki-shi (JP)

(72) Inventors: Yoshihiro Saito, Komaki-shi (JP); Takanori Ito, Komaki-shi (JP); Masanori Ishida, Komaki-shi (JP)

(73) Assignee: Sumitomo Riko Company Limited, Komaki-shi (JP)

(21) Appl. No.: 15/846,876

(22) Filed: Dec. 19, 2017

Related U.S. Application Data
(63) Continuation of application No. PCT/JP2016/062975, filed on Apr. 26, 2016.

(30) Foreign Application Priority Data
Sep. 25, 2015 (JP) 2015-187686

(51) Int. Cl. G03G 15/02

(52) U.S. Cl. CPC G03G 15/0216

(57) ABSTRACT

To provide a charging roll for an electrophotographic apparatus capable of preventing image defects such as horizontal streaks and unevenness by particles added to a surface layer, and preventing the particles from falling off from the surface layer also during the endurance time.

A charging roll 10 includes a shaft body 12, an elastic body layer 14 provided on the outer periphery of the shaft body 12, and a surface layer 16 provided on the outer periphery of the elastic body layer 14, wherein the surface layer contains (a) a binder, (b) particles having an average particle diameter of 10 to 120 micrometers, and (c) a polyphenol.

### TECHNICAL FIELD

The present invention relates to charging rolls for an electrophotographic apparatus that are suitably used in electrophotographic apparatuses such as copiers, printers, and facsimile apparatuses using a xerography method.

### BACKGROUND ART

In charging rolls for an electrophotographic apparatus, roughness forming particles are added to the surface layers to impart asperities to the surfaces.

### CITATION LIST

### Patent Literature

Patent Document 1: Patent JP2015-121769

### SUMMARY OF INVENTION

### Problems to be Solved by the Invention

In recent electrophotographic apparatuses, the power-supply voltage is set low for the purpose of reducing an environmental load and reducing costs. However, low power-supply voltage causes an insufficient discharge amount between a photo conductor and a charging roll, whereby unnecessary toner is printed to easily cause image defects such as horizontal streaks and unevenness. The asperities on the surface of the discharging roll increase the discharge space between the photo conductor and the charging roll to promote discharge. This allows the charging performance to be improved, which can prevent image defects such as horizontal streaks and unevenness. However, when particles that are large in particle diameter are added to the surface layer in order to increase the discharge space, there arises a problem in which the particles fall off from the surface layer during the endurance time.

The present invention has been made in view of the above circumstances and an object to overcome the above problems and to provide a charging roll for an electrophotographic apparatus capable of preventing image defects such as horizontal streaks and unevenness by particles added to a surface layer, and preventing the particles from falling off from the surface layer also during the endurance time.

### Means for Solving the Problem

To achieve the objects and in accordance with the purpose of the present invention, a charging roll for an electrophotographic apparatus includes a shaft body, an elastic body layer provided on an outer periphery of the shaft body, and a surface layer provided on an outer periphery of the elastic body layer. The surface layer contains

(a) a binder,
(b) particles having an average particle diameter of 10 to 120 micrometers, and
(c) a polyphenol.

It is preferable that the component (a) should be water soluble, water dispersible, or soluble in a water/alcohol mixed solvent. It is preferable that the component (b) should be at least one of a polyamide, a polyurethane, and silica. It is preferable that the component (b) should have an average particle diameter of 15 to 50 micrometers. It is preferable that the component (c) should be at least one of tannin, gallic acid, ellagic acid, pyrogallic acid, catechin, and chlorogenic acid. It is preferable that the component (c) should be hydrolyzable tannin.

### Advantageous Effects of Invention

With the charging roll for an electrophotographic apparatus according to the present invention, the particles contained in the surface layer have an average particle diameter in the range of 10 to 120 micrometers, and a binder and polyphenol in addition to particles are contained in the surface layer, which can prevent image defects such as horizontal streaks and unevenness, and preventing the particles from falling off from the surface layer also during the endurance time.

When the component (a) is water soluble, water dispersible, or soluble in the water/alcohol mixed solvent, the effect of preventing the particles from falling off from the surface layer during the endurance time can be improved. When the component (b) is at least one of a polyamide, a polyurethane, and silica, the effect of preventing the particles from falling off from the surface layer during the endurance time can be improved. When the average particle diameter of the component (b) has an average particle diameter of 15 to 50 micrometers, the charging roll is excellent in balance between the effect of preventing image defects and the effect of preventing the particles from falling off from the surface layer during the endurance time. When the component (c) is at least one of tannin, gallic acid, ellagic acid, pyrogallic acid, catechin, and chlorogenic acid, the effect of preventing the particles from falling off from the surface layer during the endurance time can be improved. When the component (c) is hydrolyzable tannin, the effect of preventing the particles from falling off from the surface layer during the endurance time can be further improved.

### BRIEF DESCRIPTION OF DRAWINGS

FIGS. 1A and 1B are perspective and radial sectional views, respectively, of a charging roll for an electrophotographic apparatus according to the first embodiment of the present invention.

FIG. 2 is an enlarged view of the charging roll illustrated in FIGS. 1A and 1B, showing the vicinity of its surface.

### MODE FOR CARRYING OUT THE INVENTION

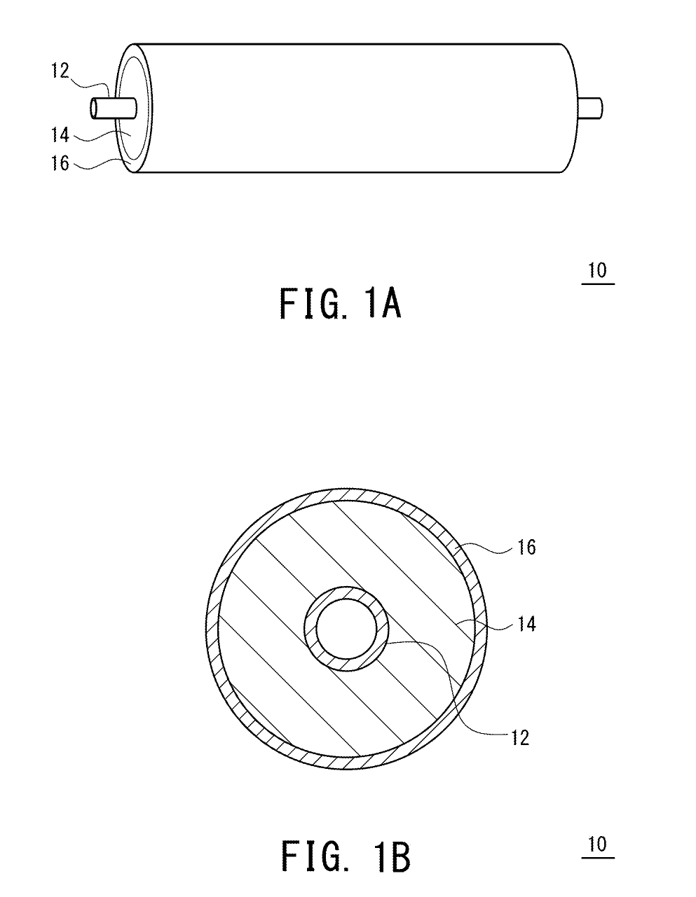

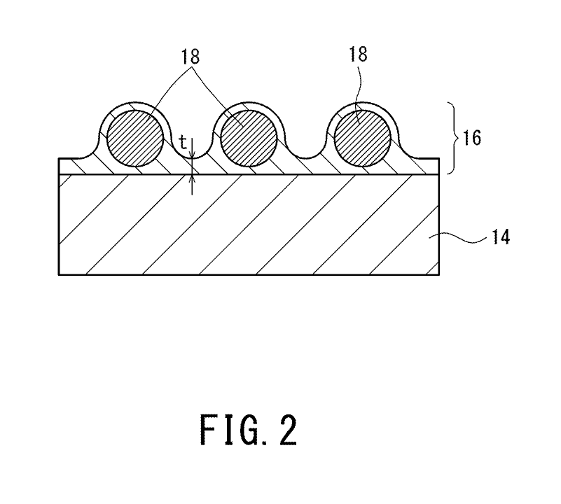

Detailed descriptions of a charging roll for an electrophotographic apparatus according to the present invention (hereinafter also referred to simply as the charging roll) will be provided. FIGS. 1A and 1B are perspective and radial sectional views, respectively, of a charging roll for an electrophotographic apparatus according to one embodiment of the present invention. FIG. 2 is an enlarged view of the charging roll illustrated in FIGS. 1A and 1B, showing the vicinity of its surface.

A charging roll 10 includes a shaft body 12, an elastic body layer 14 provided on the outer periphery of the shaft body 12, and a surface layer 16 provided on the outer periphery of the elastic body layer 14. The surface layer 16 defines a layer that appears on the surface of the charging roll 10.

The surface layer 16 contains

(a) a binder,

(b) particles having an average particle diameter of 10 to 120 micrometers, and

(c) a polyphenol.

The surface layer 16 is mainly made from (a) the binder, and examples of the binder include a polyamide (nylon) based polymer, an acrylic based polymer, a urethane based polymer, a silicone based polymer, and a fluorine based polymer. These polymers may be modified. Examples of the modifying group include an N-methoxymethyl group, a silicone group, and a fluorine group.

It is preferable that (a) the binder should be water soluble, water dispersible, or soluble in the water/alcohol mixed solvent. Water-soluble, water-dispersible, or water/alcohol mixed solvent-soluble binders define polymers that can be used as polymer components of water-based coating materials, and polymers that can be used at a concentration of 10% by mass or more in water-based coating materials. The water-based coating material is a generic name of coating materials in which auxiliary elements are mainly made of water. The water-based coating materials are divided into water-soluble resin-based water-based coating materials, and emulsion based water-based coating materials. Resins dissolved in water, coating materials colloidally dispersed in water, and emulsion coating materials are all referred to water-based coating materials. The water-soluble polymers define polymers that are dissolved in water at a solid content concentration of 10% by mass or more. The water-dispersible polymers define polymers that are dispersed in water at a solid content concentration of 10% by mass or more using an emulsifier. The polymers soluble in the water/alcohol mixed solvent define polymers that are dissolved in a water/alcohol mixed solvent at a solid content concentration of 10% by mass or more. The alcohol of the water/alcohol mixed solvent is low carbon number (lower) hydrophilic alcohol, and examples thereof include methanol, ethanol, and propanol. The upper limit of the solid content concentration of the water-soluble polymer, the water-dispersible polymer, or the polymer soluble in the water/alcohol mixed solvent is about 30% by mass.

Particles 18 of the component (b) define particles for imparting asperities to the surface of the surface layer 16, and roughness forming particles. The surface asperities increase the discharge space between a photo conductor and the charging roll 10 to promote discharge. Thus, the charging performance is improved to prevent image defects such as horizontal streaks and unevenness. When the particles 18 have an average particle diameter less than 10 micrometers, the surface layer 16 cannot secure sufficient surface roughness, and when the power-supply voltage is low, the discharge amount is insufficient between a photo conductor and the charging roll 10, whereby unnecessary toner is printed to cause image defects such as horizontal streaks and unevenness. Hence, the particles 18 of the component (b) shall have an average particle diameter of 10 micrometers or more. However, when the particles 18 have an average particle diameter of 10 micrometers or more, the particles 18 are likely to fall off from the surface layer 16 during the endurance time. If the particles 18 fall off from the surface layer 16, the discharge space is reduced, or resistance variation results, which prevents uniform charging.

It is assumed that the falling of the particles 18 is caused by decomposition of the binder or the particles 18 resulting from an electric load that is put by rubbing between a photo conductor and the charging roll 10 and discharge between a photo conductor and the charging roll 10, or decomposition of the binder or the particles 18 resulting from deterioration by ozone generated by discharge between a photo conductor and the charging roll 10. In the present invention, by making the surface layer 16 contain (c) the polyphenol, the particles 18 having an average particle diameter of 10 micrometers or more can be prevented from falling off from the surface layer 16 during the endurance time. This is, firstly, assumed to be because the hydrogen groups or hydroxyl groups in the polyphenol can act on the surfaces of the particles 18 by hydrogen bonding, whereby the three of the binder/the particles 18/the polyphenol are brought into close contact with one another by the action of the hydrogen bonding. Secondly, this is assumed to be because anti-aging action of the polyphenol can prevent decomposition of the binder or the particles 18 resulting from electrical load or ozone generated by discharge. When the binder is water soluble, water dispersible, or soluble in the water/alcohol mixed solvent, the action of hydrogen bonding is greater, and thus the effect of preventing the particles 18 from falling off from the surface layer 16 during the endurance time can be improved from the above-described first viewpoint.

It is to be noted that even in the present invention, when the particles 18 have an average particle diameter more than 120 micrometers, the particles 18 cannot be prevented from falling off from the surface layer 16 during the endurance time. Therefore, the particles 18 shall have an average particle diameter of 120 micrometers or less. The particles 18 preferably have an average particle diameter of 15 to 50 micrometers. When the particles 18 have an average particle diameter of 15 to 50 micrometers, the charging roll 10 is excellent in balance between the effect of preventing image defects and the effect of preventing the particles 18 from falling off from the surface layer 16 during the endurance time. The average particle diameter of the particles 18 is measured with the use of a laser diffraction scattering type particle size distribution meter.

The particles 18 of the component (b) may be either solid particles or porous particles. The solid particles are preferred from the viewpoint of wear resistance. Examples of the material for the particles 18 include a polyamide (nylon) based polymer, an acrylic based polymer, a urethane based polymer, a silicone based polymer, a fluorine based polymer, and silica. Among them, the polyamide (nylon) based polymer, the acrylic based polymer, the urethane based polymer, and the silica are preferred because they have a lot of hydrogen-bonding functional groups such as hydrogen groups and hydroxyl groups on their surfaces. In addition, the polyamide (nylon) based polymer and the urethane based polymer are more preferred from the viewpoint of elasticity.

The content of the particles 18 of the component (b) is not particularly limited; however, it is preferably five parts by mass or more with respect to 100 parts by mass of (a) the binder from the viewpoint of easy formation of a sufficient discharge space between a photo conductor and the charging roll 10. The content is more preferably 10 parts by mass or more, and sill, more preferably 20 parts by mass or more. Meanwhile, the content is preferably 90 parts by mass or less with respect to 100 parts by mass of (a) the binder from the viewpoint of preventing local charging unevenness caused by deposition of toner or a toner external additive in the concave portions of the surface. The content is more preferably 80 parts by mass or less, and still, more preferably 70 parts by mass or less.

Examples of (c) the polyphenol include tannin, gallic acid, ellagic acid, pyrogallic acid, catechin, and chlorogenic acid. Among them, a single kind of polyphenol may be used alone, or two or more kinds of polyphenols may be used in combination. Tannins are broadly divided into hydrolyzable tannin and condensed tannin in accordance with the difference in chemical structure. The condensed tannin has a configuration where molecules of catechin are condensed by a carbon-carbon bond. The hydrolyzable tannin is made of polyvalent phenolic acid and polyhydric alcohol, and is hydrolyzed to generate polyvalent phenolic acid and polyhydric alcohol. Examples of the polyvalent phenolic acid in the hydrolyzable tannin include gallic acid, a dimer of gallic acid, and ellagic acid. The tannin in which the polyvalent phenolic acid is gallic acid defines gallotannin, and the tannin in which the polyvalent phenolic acid is a dimer of gallic acid or ellagic acid defines ellagitannin. Examples of the polyhydric alcohol include sugars (glucose) and cyclic polyalcohol other than sugars. Tannin in the hydrolyzable tannin defines tannin obtained from a galla or gallnut, and defines a compound in which gallic acid is ester-bonded to all of the hydroxyl groups of the glucose, and is further ester-bonded to the phenolic hydroxyl group.

It is preferable that the tannin should be hydrolyzable tannin from the viewpoints of having excellent solubility or dispersibility in a (water-based) solvent, having excellent coating properties as a surface layer forming material, and further improving the effect of preventing the particles from falling off from the surface layer 16 during the endurance time. The hydrolyzable tannin is decomposed by water, oxygen, or the like, and the decomposition product includes polyvalent phenolic acid. That is, the degradation product is also polyphenol, and has the function of reducing substances having oxidation nature.

The content of (C) the polyphenols is not particularly limited; however, it is preferably 0.3 parts by mass or more with respect to 100 parts by mass of (a) the binder from the viewpoint of ensuring the amount of the hydrogen bonding to have the excellent effect of preventing the particles from falling off from the surface layer 16 during the endurance time. The content is more preferably 0.5 parts by mass or more, and sill, more preferably 1.0 part by mass or more. Meanwhile, the content is preferably 5.0 parts by mass or less with respect to 100 parts by mass of (a) the binder from the viewpoint of ensuring toughness of the surface layer 16 to easily prevent the surface layer 16 from cracking during the endurance time. The content is more preferably 4.5 parts by mass or less, and still, more preferably 4.0 parts by mass or less.

It is possible to add conventionally known conductive agents such as a carbon black, graphite, c-TiO₂, c-ZnO, c-SnO₂ (c- means conductivity.), ion conductive agents (e.g., a quaternary ammonium salt, a borate salt, and a surface acting agent) to the surface layer 16 as appropriate in order to impart conductivity. In addition, a variety of additives may be added as appropriate if needed. Examples of the additives include a lubricant, a vulcanization accelerator, an anti-aging agent, a light stabilizer, a viscosity modifier, a processing aid, a flame retardant, a plasticizer, a foaming agent, a filler, a dispersing agent, an antifoaming agent, a pigment, and a mold-releasing agent.

The surface roughness (Rz) of the surface layer 16 is not particularly limited; however, it is preferably 10 micrometers or more from the viewpoint of easy formation of a sufficient discharge space between a photo conductor and a charging roll. The surface roughness is more preferably 15 micrometers or more, yet more preferably 20 micrometers or more, and most preferably 25 micrometers or more. Meanwhile, the surface roughness is 90 micrometers or less from the viewpoint of easily preventing the particles from falling off from the surface layer 16 during the endurance time. The surface roughness is more preferably 70 micrometers or less, yet more preferably 50 micrometers or less, and most preferably 40 micrometers or less. The surface roughness (Rz) of the surface layer 16 is a ten-point average roughness, and is measured in accordance with the JIS B0601 (1994). The surface roughness (Rz) of the surface layer 16 can be adjusted depending on the particle size or the amount of the particles 18, or the binder amount.

The thickness of the surface layer 16 is not particularly limited; however, it is preferably in the range of 3.0 to 20 micrometers, and more preferably in the range of 5.0 to 15 micrometers. The thickness of the surface layer 16 defines a thickness t in the portion where no particles are present as illustrated in FIG. 2. The volume resistivity of the surface layer 16 is preferably in the range of 10⁴ to 10⁹ Ω·cm, yet more preferably in the range of 10⁵ to 10⁸ Ω·cm, and most preferably in the range of 10⁶ to 10⁷ Ω·cm.

The shaft body 12 is not particularly limited as long as it has conductivity. To be specific, examples of the shaft body 12 include a solid member consisting of a solid body or a hollow body made from metal such as iron, stainless steel, and aluminum. An adhesive or a primer may be applied to the surface of the shaft body 12 as necessary. That is, the elastic body layer 14 may be bonded to the shaft body 12 via an adhesive layer (a primer layer). The adhesive and the primer may be made conductive as necessary.

The elastic body layer 14 contains crosslinked rubber. The elastic body layer 14 is made from a conductive rubber composition containing uncrosslinked rubber. The crosslinked rubber can be obtained by crosslinking uncrosslinked rubber. The uncrosslinked rubber may be polar rubber, or non-polar rubber. Polar rubber is preferred as the uncrosslinked rubber from the viewpoint of having excellent conductivity.

Polar rubber is rubber having a polar group, and examples of the polar group include a chloro group, a nitrile group, a carboxyl group, and an epoxy group. Specific examples of the polar rubber include hydrin rubber, nitrile rubber (NBR), urethane rubber (U), acrylic rubber (a copolymer of acrylic acid ester and 2-chloroethyl vinyl ether, ACM), chloroprene rubber (CR), and epoxidized natural rubber (ENR). Among the polar rubbers, hydrin rubber and nitrile rubber (NBR) are preferred from the viewpoint of easily achieving a very low volume resistivity.

Examples of the hydrin rubber include a homopolymer of epichlorohydrin (CO), an epichlorohydrin-ethylene oxide binary copolymer (ECO), an epichlorohydrin-allyl glycidyl ether binary copolymer (GCO), and an epichlorohydrin-ethylene oxide-allyl glycidyl ether ternary copolymer (GECO).

Examples of the urethane rubber include polyether type urethane rubber having an ether bond in the molecule. The polyether type urethane rubber can be produced by reaction of a polyether having a terminal hydroxyl group and a diisocyanate. The polyether is not particularly limited; however, examples of the polyether include a polyethylene glycol and a polypropylene glycol. The diisocyanate is not particularly limited; however, examples of the diisocyanate include a tolylene diisocyanate and a diphenylmethane diisocyanate.

Examples of the crosslinking agent include a sulfur crosslinking agent, a peroxide crosslinking agent, and a dechlorination crosslinking agent. Among them, a single kind of crosslinking agent may be used alone, or two or more kinds of crosslinking agents may be used in combination.

Examples of the sulfur cross-linking agent include conventionally known sulfur cross-linking agents such as powdered sulfur, precipitated sulfur, colloidal sulfur, surface treated sulfur, insoluble sulfur, sulfur chloride, a thiuram vulcanization accelerator, and a polymer polysulfide.

Examples of the peroxide crosslinking agent include conventionally known crosslinking agents such as a peroxy ketal, a dialkyl peroxide, a peroxy ester, a ketone peroxide, a peroxydicarbonate, a diacyl peroxide, and a hydroperoxide.

Examples of the dechlorination crosslinking agent include dithiocarbonate compounds. Specific examples thereof include quinoxaline-2,3-dithiocarbonate, 6-methylquinoxaline-2,3-dithiocarbonate, 6-isopropylquinoxaline-2,3-dithiocarbonate, and 5,8-dimethylquinoxaline-2,3 dithiocarbonate.

The amount of the crosslinking agent is preferably in the range of 0.1 to 2 parts by mass with respect to 100 parts by mass of the uncrosslinked rubber, more preferably in the range of 0.3 to 1.8 parts by mass, and still, more preferably in the range of 0.5 to 1.5 parts by mass from the viewpoint of not easily bleeding.

When using a dechlorination crosslinking agent as the crosslinking agent, a dechlorination crosslinking accelerator may be used in combination. Examples of the dechlorination crosslinking accelerator include 1,8-diazabicyclo (5,4,0) undecene-7 (hereinafter abbreviated as DBU) and a weak acid salt thereof. The dechlorination crosslinking accelerator may be used in the form of DBU; however, it is preferably used in the form of a weak acid salt from the viewpoint of ease in handling. Examples of the weak acid salt of DBU include a carbonate, a stearate, a 2-ethylhexylate, a benzoate, a salicylate, a 3-hydroxy-2-naphthoate, a phenol resin salt, a 2-mercaptobenzothiazole salt, and a 2-mercaptobenzimidazole salt.

The content of the dechlorination crosslinking accelerator is preferably in the range of 0.1 to 2 parts by mass with respect to 100 parts by mass of the uncrosslinked rubber, more preferably in the range of 0.3 to 1.8 parts by mass, and still, more preferably in the range of 0.5 to 1.5 parts by mass from the viewpoint of not easily bleeding.

It is possible to add conventionally known conductive agents such as a carbon black, graphite, c-TiO₂, c-ZnO, c-SnO₂ (c- means conductivity.), ion conductive agents (e.g., a quaternary ammonium salt, a borate salt, and a surface acting agent) to the elastic body layer 14 as appropriate in order to impart conductivity. In addition, a variety of additives may be added to the elastic body layer 14 as appropriate if needed. Examples of the additives include a lubricant, a vulcanization accelerator, an anti-aging agent, a light stabilizer, a viscosity modifier, a processing aid, a flame retardant, a plasticizer, a foaming agent, a filler, a dispersing agent, an antifoaming agent, a pigment, and a mold-releasing agent.

The elastic body layer 14 can be adjusted to have a predetermined volume resistivity depending on the type of an uncrosslinked rubber, the amount of an ion conductive agent, or the composition of an electroconductive agent. The volume resistivity of the elastic body layer 14 may be set as appropriate in the range of 10² to 10¹⁰ Ω·cm, in the range of 10³ to 10⁹ Ω·cm, or in the range of 10⁴ to 10⁸ Ω·cm.

The thickness of the elastic body layer 14 is not particularly limited, and may be set as appropriate in the range of 0.1 to 10 mm depending on the intended use.

The charging roll 10 can be produced as follows, for example. First, the elastic body layer 14 is famed on the outer periphery of the shaft body 12 by coaxially installing the shaft body 12 in a hollow portion of a roll molding die and injecting an uncrosslinked conductive rubber composition thereinto to heat/cure (crosslink) the composition, and then releasing it from the die, or by extrusion-molding an uncrosslinked conductive rubber composition on the surface of the shaft body 12. Next, the surface layer 16 is famed by coating the outer periphery of the famed elastic body layer 14 with a surface layer forming composition and subjecting the composition to crosslinking treatment such as ultraviolet irradiation or heat treatment as necessary. Thus, the charging roll 10 can be produced. A variety of coating methods such as a roll coating method, a dipping method, and a spray coating method can be used. The surface layer 16, if famed by coating, can be famed thinly and uniformly, whereby uniform surface resistivity can be easily obtained.

The charging roll 10 having the above-described configuration includes the surface layer 16 that contains the particles 18 having an average particle diameter in the range of 10 to 120 micrometers, and that contains the binder and the polyphenol in addition to the particles 18, whereby image defects such as horizontal streaks and unevenness can be prevented, and the particles 18 can be also prevented from falling off from the surface layer 16 also during the endurance time.

The configuration of the charging roll according to the present invention is not limited to the configuration illustrated in FIGS. 1A and 1B. For example, the charging roll 10 illustrated in FIGS. 1A and 1B may have a configuration of including another elastic body layer between the shaft body 12 and the elastic body layer 14. In this case, the another elastic body layer defines a base layer of the charging roll, and the elastic body layer 14 functions as a resistance adjusting layer arranged to adjust the resistance of the charging roll. The another elastic body layer can be made from, for example, any of the above-described materials from which the elastic body layer 14 is made.

In addition, the charging roll 10 illustrated in FIGS. 1A and 1B may have a configuration of including another elastic body layer between the elastic body layer 14 and the surface layer 16. In this case, the elastic body layer 14 defines a base layer of the charging roll, and the another elastic body layer functions as a resistance adjusting layer arranged to adjust the resistance of the charging roll. The another elastic body layer can be made from, for example, any of the above-described materials from which the elastic body layer 14 is made.

### EXAMPLE

Hereinafter, the present invention will be described in detail with reference to examples and comparative examples.

### Example 1

<Preparation of Conductive Rubber Composition>

A conductive rubber composition was prepared by adding three parts by mass of an ion conductive agent (tetra-n-butylammonium perchlorate, n-Bu₄N.ClO₄), two parts by mass of sulfur (“SULFUR-PTC” manufactured by TSURUMI CHEMICAL INDUSTRY CO., LTD.) as a crosslinking agent were added to 100 parts by mass of hydrin rubber (ECO, “HydrinT3106” manufactured by ZEON CORPORATION), and they were agitated and mixed with the use of an agitator.

<Preparation of Surface Layer Forming Composition>

A surface layer forming composition was prepared by mixing 100 parts by mass of a nylon paint (as a solid content), 0.3 parts by mass of tannin (a reagent manufactured by KANTO CHEMICAL CO., INC.), five parts by mass of acrylic particles (having an average particle size of 120 micrometers), and 30 parts by mass of a carbon black dispersion liquid.

<Preparation of Charging Roll>

A core metal (a shaft body having a diameter of 8 mm) was installed in a molding die, the above-described conductive rubber composition was injected into the molding die to be heated for 30 minutes at 170 degrees C., cooled, and released from the die, and thus an elastic body layer having a thickness of 1.5 mm was famed around the outer periphery of the core metal. Then, the outer peripheral surface of the elastic body layer was roll coated with the above-described surface layer forming composition, and the composition was heated for 50 minutes at 120 degrees C., and thus a surface layer was famed on the outer periphery of the elastic body layer (thickness t=10 micrometers, surface roughness Rz=25 micrometers). A charging roll was produced in this manner.

### Example 2

A charging roll was produced in a manner similar to Example 1 except that the amount of the acrylic particles was changed in the surface layer forming composition.

### Examples 3 to 4

Charging rolls were produced in a manner similar to Examples 1 and 2 except that the amounts of the tannin were changed in the surface layer forming compositions.

### Examples 5 to 7, 13, and 14

Charging rolls were produced in a manner similar to Example 1 except that the amounts of the tannin were changed and that the types and the amounts of the particles were changed in the surface layer forming compositions.

### Example 8

A charging roll was produced in a manner similar to Example 6 except that the nylon paint was replaced with a urethane paint in the surface layer forming composition.

### Examples 9 to 10

Charging rolls were produced in a manner similar to Example 6 except that the amounts of the tannin were changed in the surface layer forming compositions.

### Example 11

A charging roll was produced in a manner similar to Example 6 except that the tannin was replaced with gallic acid in the surface layer forming composition.

### Example 12

A charging roll was produced in a manner similar to Example 6 except that the type of the acrylic particles was changed in the surface layer forming composition.

### Comparative Example 1

A charging roll was produced in a manner similar to Example 6 except that no tannin was contained in the surface layer forming composition.

### Comparative Examples 2 to 3

Charging rolls were produced in a manner similar to Example 6 except that the types of the particles were changed in the surface layer forming compositions.

The components used are as follows:

Nylon paint: solid content: N-methoxymethylated 6-nylon at a solid content concentration of 20% by mass, solvent: methanol, “TORESIN F-30K” manufactured by NAGASE CHEMTEX CORPORATION, SP value: 10.91

Urethane paint: a urethane resin aqueous emulsion at a solid content concentration of 40% by mass, solvent: water, “EVAFANOL HA107C” manufactured by NICCA CHEMICAL CO., LTD.

Acrylic particles (having an average particle diameter of six micrometers): “Art-pearl GR-800” manufactured by NEGAMI CHEMICAL INDUSTRIAL CO., LTD

Acrylic particles (having an average particle diameter of 10 micrometers): “Art-pearl GR-600” manufactured by NEGAMI CHEMICAL INDUSTRIAL CO., LTD

Acrylic particles (having an average particle diameter of 60 micrometers): “TAFTIC AR650MZ” manufactured by TOYOBO CO., LTD.,

Acrylic particles (having an average particle diameter of 120 micrometers): “Art-pearl GR-50W” manufactured by NEGAMI CHEMICAL INDUSTRIAL CO., LTD

Acrylic particles (having an average particle diameter of 150 micrometers): “TAFTIC AR650LL” manufactured by TOYOBO CO., LTD.,

Urethane particles (having an average particle diameter of 50 micrometers): “Art-pearl C-100” manufactured by NEGAMI CHEMICAL INDUSTRIAL CO., LTD

Silica particles (having an average particle diameter of 30 micrometers): “QSG-30” manufactured by SHIN-ETSU CHEMICAL CO., LTD.

Polyamide particles (having an average particle diameter of 40 micrometers): “ORGASOL 2002ES4NAT3” manufactured by ARKEMA K.K.

Carbon black dispersion liquid: “AQUA-BLACK001” manufactured by TOKAI CARBON CO., LTD. at a solid content concentration of 19% by mass, solvent: water

Evaluations of each of the charging rolls thus produced were made in tams of image defect, particle falling, and surface layer cracking. Evaluation methods and evaluation criteria are as follows. Results of the evaluations and composition (parts by mass) of surface layer forming compositions are listed in the table.

(Image Defects)

Each of the charging rolls was installed in a commercially available full color MFP (“iR-ADV C9280PRO” manufactured by CANON INC.), and then 200 k sheets of half-tone image were outputted under an environment of 25 degrees C. and 50% RH. The charging rolls with which favorable images without horizontal streaks, toner fogging, or unevenness were obtained were rated “very good”, the charging rolls with which images without horizontal streaks, toner fogging, or unevenness were obtained were rated “average”, and the charging rolls with which images with any one of horizontal streaks, toner fogging, and unevenness were obtained were rated “poor”.

(Particle Falling)

Each of the charging rolls was installed in a commercially available full color MFP (“iR-ADV C9280PRO” manufactured by CANON INC.), and then 200 k sheets of half-tone image were outputted under an environment of 25 degrees C. and 50% RH. Then, randomly-selected ten points on the surface of each of the charging rolls were observed under a commercially available laser microscope at a magnification of 400 times. The charging rolls in which no particle falling was observed and that maintain surfaces having favorable particle peripheries were rated “very good”, the charging rolls in which no particle falling was observed were rated “average”, and the charging rolls in which particle falling was observed were rated “poor”.

(Surface Layer Cracking)

Each of the charging rolls was installed in a commercially available full color MFP (“iR-ADV C9280PRO” manufactured by CANON INC.), and then 200 k sheets of half-tone image were outputted under an environment of 25 degrees C. and 50% RH. Then, randomly-selected ten points on the surface of each of the charging rolls were observed under a commercially available laser microscope at a magnification of 400 times. The charging rolls in which no crack was observed and that maintain favorable surfaces were rated “very good”, the charging rolls in which no crack was observed were rated “average”, and the charging rolls in which a crack was observed were rated “poor”.

TABLE 1

| Surface layer | | | | | | | | | | | | | | | Comparative | | |
|---|---|---|---|---|---|---|---|---|---|---|---|---|---|---|---|---|---|
| forming | Example | | | | | | | | | | | | | | Example | | |
| composition | 1 | 2 | 3 | 4 | 5 | 6 | 7 | 8 | 9 | 10 | 11 | 12 | 13 | 14 | 1 | 2 | 3 |
| Nylon paint | 100 | 100 | 100 | 100 | 100 | 100 | 100 | — | 100 | 100 | 100 | 100 | 100 | 100 | 100 | 100 | 100 |
| (solid content) | | | | | | | | | | | | | | | | | |
| Urethane paint | — | — | — | — | — | — | — | 100 | — | — | — | — | — | — | — | — | — |
| (solid content) | | | | | | | | | | | | | | | | | |
| Tannin | 0.3 | 0.3 | 5.0 | 5.0 | 1.0 | 1.0 | 1.0 | 1.0 | 0.2 | 5.5 | — | 1.0 | 1.0 | 1.0 | — | 1.0 | 1.0 |
| Gallic acid | — | — | — | — | — | — | — | — | — | — | 1.0 | — | — | — | — | — | — |
| Acrylic particles | — | — | — | — | — | — | — | — | — | — | — | — | — | — | — | 50 | — |
| (5 μm) | | | | | | | | | | | | | | | | | |
| Acrylic particles | — | — | — | — | 50 | — | — | — | — | — | — | — | — | — | — | — | — |
| (10 μm) | | | | | | | | | | | | | | | | | |
| Acrylic particles | — | — | — | — | — | 50 | — | 50 | 50 | 50 | 50 | — | — | — | 50 | — | — |
| (60 μm) | | | | | | | | | | | | | | | | | |
| Acrylic particles | 5 | 90 | 5 | 90 | — | — | — | — | — | — | — | 50 | — | — | — | — | — |
| (120 μm) | | | | | | | | | | | | | | | | | |
| Acrylic particles | — | — | — | — | — | — | — | — | — | — | — | — | — | — | — | — | 50 |
| (150 μm) | | | | | | | | | | | | | | | | | |
| Urethane particles | — | — | — | — | — | — | 50 | — | — | — | — | — | — | — | — | — | — |
| (50 μm) | | | | | | | | | | | | | | | | | |
| Silica particles | — | — | — | — | — | — | — | — | — | — | — | — | 50 | — | — | — | — |
| (30 μm) | | | | | | | | | | | | | | | | | |
| Polyamide particles | — | — | — | — | — | — | — | — | — | — | — | — | — | 50 | — | — | — |
| (40 μm) | | | | | | | | | | | | | | | | | |
| Carbon black | 30 | 30 | 30 | 30 | 30 | 30 | 30 | 30 | 30 | 30 | 30 | 30 | 30 | 30 | 30 | 30 | 30 |
| dispersion liquid | | | | | | | | | | | | | | | | | |
| Image defects | Very | Very | Very | Very | Very | Very | Very | Very | Average | Average | Very | Very | Very | Very | Poor | Poor | Poor |
| | good | good | good | good | good | good | good | good | | | good | good | good | good | | | |
| Particle falling | Very | Very | Very | Very | Very | Very | Very | Very | Average | Very | Very | Very | Very | Very | Poor | Very | Poor |
| | good | good | good | good | good | good | good | good | | good | good | good | good | good | | good | |
| Surface layer | Very | Very | Very | Very | Very | Very | Very | Very | Very | Average | Very | Very | Very | Very | Very | Very | Very |
| cracking | good | good | good | good | good | good | good | good | good | | good | good | good | good | good | good | good |

In Comparative Example 1, no polyphenol was contained in the surface layer, resulting in particle falling, which produced image defects. In Comparative Example 2, the size of the particles contained in the surface layer was too small, which produced image defects. In Comparative Example 3, the size of the particles contained in the surface layer was too large, resulting in particle falling, which produced image defects. Meanwhile, in the present examples, each surface layer contained the binder, the particles having an average particle diameter of 10 to 120 micrometers, and the polyphenol, whereby image defects such as horizontal streaks and unevenness were prevented, and the particles were prevented from falling off from the surface layer also during the endurance time. Therefore, it is understood that since each surface layer contained the binder, the particles having an average particle diameter of 10 to 120 micrometers, and the polyphenol, image defects such as horizontal streaks and unevenness were prevented, and the particles were prevented from falling off from the surface layer also during the endurance time.

From comparison among the present examples, it is understood that when the amount of the polyphenol was 0.3 to 5.0 parts by mass with respect to 100 parts by mass of the binder, the charging rolls were excellent in balance between the effect of preventing image defects and the effect of preventing the particles from falling off from the surface layer during the endurance time.

Having thus described in detail embodiments of the present invention, the present invention is not intended to be limited to the above embodiments, various modifications are possible without departing from the scope of the present invention.

1-6. (canceled)

7. A charging roll for an electrophotographic apparatus comprising:
a shaft body;
an elastic body layer provided on an outer periphery of the shaft body; and
a surface layer provided on an outer periphery of the elastic body layer, the surface layer comprising:
(a) a binder that comprises at least one of a nylon based polymer and a urethane based polymer and is water soluble, water dispersible, or soluble in a water/alcohol mixed solvent;
(b) particles that comprise at least one of a polyamide, an acrylic polymer, a polyurethane, and silica and that have an average particle diameter of 15 to 50 micrometers; and
(c) hydrolyzable tannin.

8. The charging roll for an electrophotographic apparatus according to claim 7,
wherein the surface layer has a thickness of 5.0 to 15 micrometers.

9. The charging roll for an electrophotographic apparatus according to claim 8,
wherein the surface layer has a surface roughness of 25 to 40 micrometers.

10. The charging roll for an electrophotographic apparatus according to claim 9,
wherein the content of the component (b) in the surface layer is in a range of 20 to 70 parts by mass.

11. The charging roll for an electrophotographic apparatus according to claim 10,
wherein the content of the component (c) in the surface layer is in a range of 1.0 to 4.0 parts by mass.

12. The charging roll for an electrophotographic apparatus according to claim 11,
wherein the elastic body layer comprises an epichlorohydrin-ethylene oxide binary copolymer, and
the surface layer comprises:
the nylon based polymer as the component (a); and
the acrylic polymer as the component (b).

13. The charging roll for an electrophotographic apparatus according to claim 7,
wherein the surface layer has a surface roughness of 25 to 40 micrometers.

14. The charging roll for an electrophotographic apparatus according to claim 7,
wherein the content of the component (b) in the surface layer is in a range of 20 to 70 parts by mass.

15. The charging roll for an electrophotographic apparatus according to claim 7,
wherein the content of the component (c) in the surface layer is in a range of 1.0 to 4.0 parts by mass.

16. The charging roll for an electrophotographic apparatus according to claim 7,
wherein the elastic body layer comprises an epichlorohydrin-ethylene oxide binary copolymer, and
the surface layer comprises:
the nylon based polymer as the component (a); and
the acrylic polymer as the component (b).
